(19) United States
(12) Patent Application Publication
(10) Pub. No.: US 2020/0369021 A1
(43) Pub. Date: Nov. 26, 2020

(54) SCREEN-FRAME ATTACHMENT APPARATUS AND PLATE-MAKING PRINTING SYSTEM

(71) Applicant: RISO KAGAKU CORPORATION, Tokyo (JP)

(72) Inventor: Takeshi HIGUCHI, Tsukuba (JP)

(73) Assignee: RISO KAGAKU CORPORATION, Tokyo (JP)

(21) Appl. No.: 16/816,774

(22) Filed: Mar. 12, 2020

(30) Foreign Application Priority Data
May 24, 2019 (JP) 2019-097812

(51) Int. Cl. B41F 15/08; B41F 15/34

(52) U.S. Cl. CPC B41F 15/08; B41F 15/34

(57) ABSTRACT

A screen-frame attachment apparatus to which a screen frame for holding a screen is to be attached, the screen-frame attachment apparatus including: an apparatus-side positioning part that positions the screen frame, the apparatus-side positioning part being associated with a frame-side positioning part provided on a periphery of the screen frame, wherein the apparatus-side positioning part positions the screen frame in accordance with a projection provided on one of the apparatus-side positioning part or the frame-side positioning part being inserted into a recess provided in another of the two parts.

### CROSS-REFERENCE TO RELATED APPLICATION

This application is based upon and claims the benefit of priority of the prior Japanese Patent Application No. 2019-097812, filed on May 24, 2019, the entire contents of which are incorporated herein by reference.

### FIELD

The aspects described herein are related to a screen-frame attachment apparatus to which a screen frame is to be attached and a plate-making printing system that includes a plate-making apparatus and a printing apparatus that each have a screen frame to be attached thereto.

### BACKGROUND

Plate-making apparatuses for screen printing have conventionally been such that portions for printing of screens held by screen frames are, for example, thermosensitively perforated by thermal heads. Alternatively, plate making may be performed by curing a chemical agent on portions of a mesh-like screen other than the portions for printing.

After a screen has been fabricated, a user removes the screen frame from the plate-making apparatus, attaches this frame to the printing apparatus, and applies ink to an object for printing through holes in the screen by means of a squeegee.

When attaching a screen frame to a plate-making apparatus or a printing apparatus, the accuracy of the position of the screen frame needs to be ensured for a front-rear direction and a left-right direction. Accordingly, a proposed technique is, for example, such that reference planes are provided on the periphery of a screen frame so as to adjust positions for the front-rear direction and for the left-right direction (e.g., Japanese Laid-open Patent Publication No. 11-42761).

### SUMMARY

A screen-frame attachment apparatus in one aspect is one to which a screen frame for holding a screen is to be attached, the screen-frame attachment apparatus including: an apparatus-side positioning part that positions the screen frame, the apparatus-side positioning part being associated with a frame-side positioning part provided on a periphery of the screen frame, wherein the apparatus-side positioning part positions the screen frame in accordance with a projection provided on one of the apparatus-side positioning part or the frame-side positioning part being inserted into a recess provided in another of the two parts.

The object and advantages of the present invention will be realized by the elements recited in the claims or combinations thereof.

### BRIEF DESCRIPTION OF DRAWINGS

FIG. 1 is a perspective view illustrating a plate-making apparatus and a screen frame;

FIG. 2 is a perspective view for illustrating position adjustment of a screen frame for a plate-making apparatus;

FIG. 3 is a perspective view illustrating an apparatus-side positioning member and other components of a plate-making apparatus (example 1);

FIG. 4 is a perspective view illustrating an apparatus-side positioning member and other components of a plate-making apparatus (example 2);

FIG. 5 is an exploded perspective view illustrating a screen frame;

FIG. 6 is a right side view illustrating a printing apparatus and a screen frame;

FIG. 7 is an enlarged right side view illustrating a holding part and an apparatus-side positioning member of a printing apparatus;

FIG. 8 is a perspective view for illustrating position adjustment of a screen frame for a printing apparatus;

FIG. 9 is a perspective view illustrating a holding part and an apparatus-side positioning part of a printing apparatus;

FIG. 10 is an exploded perspective view illustrating a holding part and an apparatus-side positioning member of a printing apparatus;

FIG. 11 is a perspective view illustrating a holding part and an apparatus-side positioning member in accordance with a variation;

FIG. 12 is a perspective view for illustrating position adjustment of a screen frame in accordance with a comparative example (example 1); and

FIG. 13 is a perspective view for illustrating position adjustment of a screen frame in accordance with a comparative example (example 2).

### DESCRIPTION OF EMBODIMENTS

Adjusting the position of a screen frame for a front-rear direction and for a left-right direction by means of reference planes on the screen frame, as described above, would require a position adjustment mechanism for the front-rear direction and a position adjustment mechanism for the left-right direction. This will result in an increase in the size of a plate-making apparatus or printing apparatus to which the screen frame is to be attached and cause troubles with, or require efforts for, the position adjustment of the screen frame.

In particular, a printing apparatus holds one edge of a screen frame in a sandwiching manner by means of a holding part. To adjust the position of the screen frame relative to the holding part, abutment members which the screen frame is to abut could be disposed on two adjacent edges of the screen frame, and the position of the screen frame could be adjusted with reference to a corner between the two edges. However, as there are various sized screen frames, such a technique could involve troubles or require efforts, e.g., for each individual edge, the abutment member could need to be moved.

The following describes a screen-frame attachment apparatus and a plate-making printing system in accordance with embodiments of the present invention by referring to the drawings.

In embodiments, a plate-making apparatus 10 and a printing apparatus 20 each function as an example of a screen-frame attachment apparatus to which a screen frame 1 is to be attached. The plate-making apparatus 10 and the printing apparatus 20 may be deemed as portions of a plate-making printing system. In other words, the plate-making printing system includes the plate-making apparatus 10 and the printing apparatus 20.

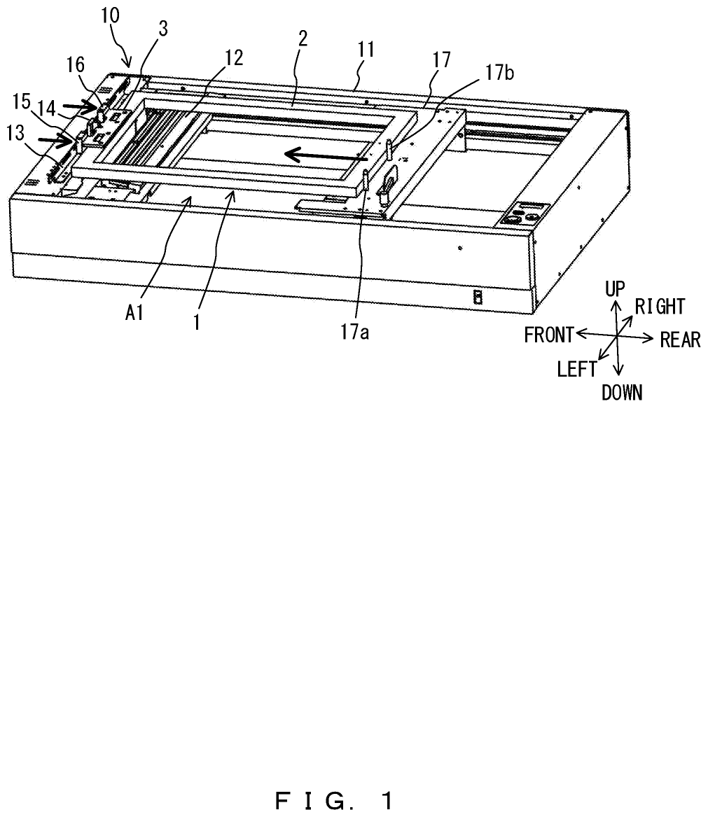

FIG. 1 is a perspective view illustrating the plate-making apparatus 10 and the screen frame 1.

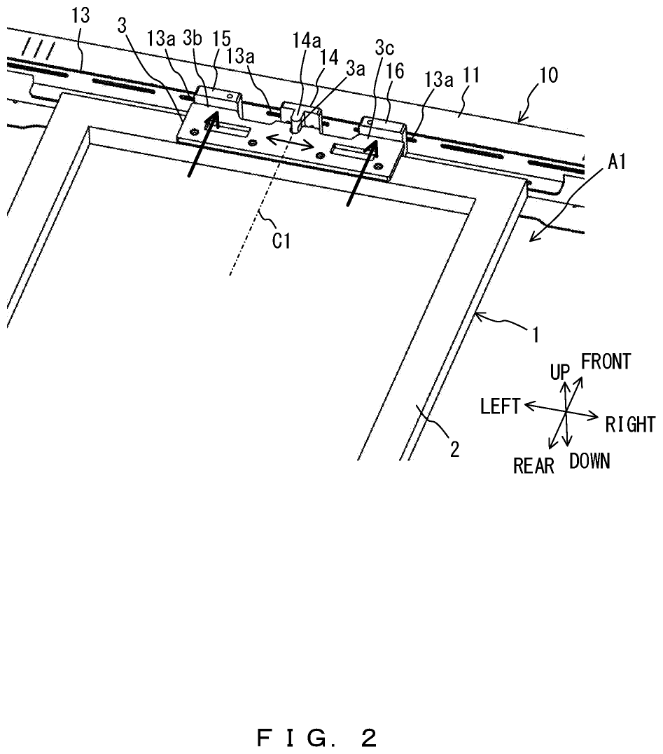

FIG. 2 is a perspective view for illustrating position adjustment of the screen frame 1 for the plate-making apparatus 10.

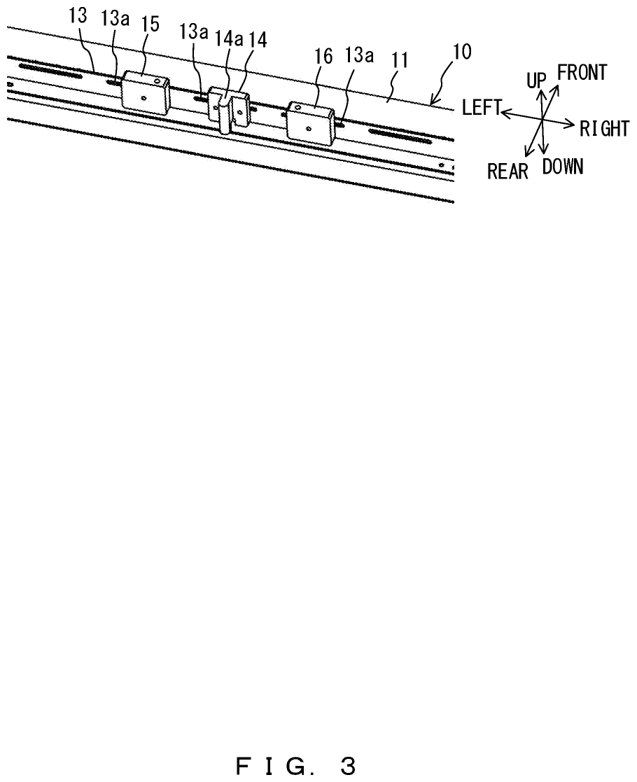

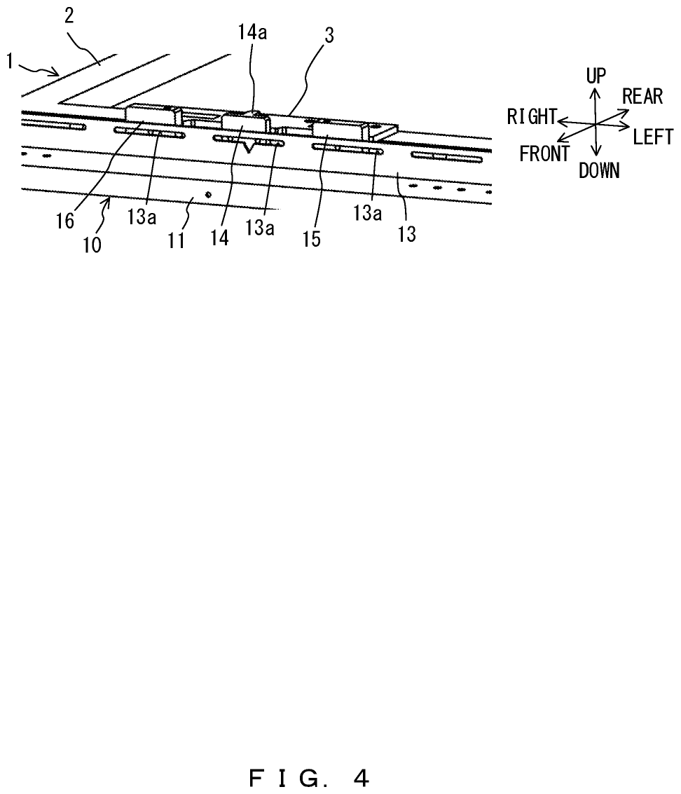

FIGS. 3 and 4 are perspective views illustrating an apparatus-side positioning member 14 and other components of the plate-making apparatus 10.

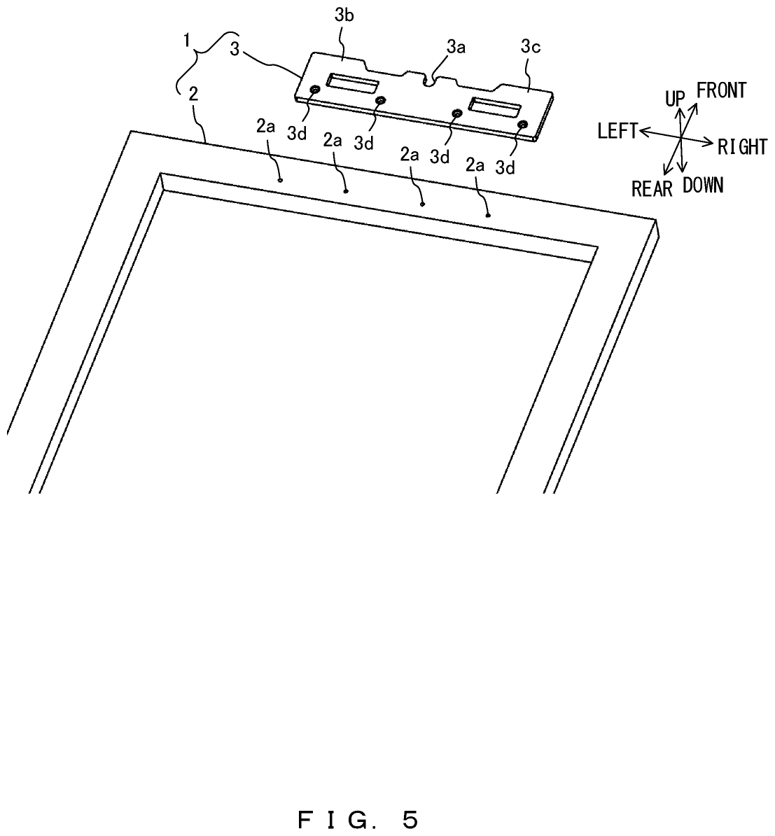

FIG. 5 is an exploded perspective view illustrating the screen frame 1.

A front-rear direction, an up-down direction, and a left-right direction indicated in FIGS. 1-5 and FIGS. 6-13, which will be described hereinafter, are merely examples for which the abutment direction of the screen frame 1 (top side) is defined as a front direction. For example, the front-rear direction and the left-right direction may each be a horizontal direction, and the up-down direction may be a vertical direction.

As depicted in FIG. 1, the plate-making apparatus 10 includes a frame-shaped body 11, a plate-making part 12, an attachment member 13, an apparatus-side positioning member 14, abutment members 15 and 16, and a slide member 17.

The frame-shaped body 11 is shaped like a rectangular frame and has an upper portion to which the screen frame 1 is to be attached.

The plate-making part 12 includes a platen located at either a position above (not illustrated) or a position below the screen frame 1 and a thermal head located at the other of these positions. This thermal head moves in the front-rear direction (or the front-rear direction and the left-right direction) together with the platen and, on the basis of image data, thermosensitively perforates a region of a portion for printing of a screen held on, for example, the bottom surface of the screen frame 1. The method of forming holes in a portion for printing of the screen is not limited to the thermosensitive perforation using a thermal head. For example, a technique may be used for curing a photo-curing chemical agent on the portions of a mesh-like screen other than portions for printing.

The attachment member 13 is, for example, an L-shaped sheet metal disposed on an upper-front surface of the frame-shaped body 11. As depicted in FIGS. 3 and 4, a plurality of long holes 13a arranged in the left-right direction are formed through the attachment member 13 in the front-rear direction. The long holes 13a are longer in the left-right direction than in the up-down direction.

As depicted in FIGS. 2-4, the apparatus-side positioning member 14 is attached at a long hole 13a in the attachment member 13 by using a screw (not illustrated). The apparatus-side positioning member 14 is an example of the apparatus-side positioning part that positions the screen frame 1. The apparatus-side positioning member 14 is provided with a projection 14a protruding rearward, i.e., toward the screen frame 1. The projection 14a is inserted into a recess 3a of a frame-side positioning member 3 of the screen frame 1, which will be described hereinafter. When the frame-side positioning member 3 of the screen frame 1 is provided with a projection protruding frontward, in place of the recess 3a, the apparatus-side positioning member 14 may include, in a rear edge portion (screen-frame-1 side) thereof, a recess into which the projection is to be inserted. The projection 14a may be provided on the frame-shaped body 11 or the like, rather than on the apparatus-side positioning member 14 attached to the frame-shaped body 11 (attachment member 13). In this case, the projection alone functions as the apparatus-side positioning part. The apparatus-side positioning part (apparatus-side positioning member 14) and the frame-side positioning part (frame-side positioning member 3) do not necessarily perform the positioning using the projection 14a and the recess 3a but may perform the positioning using another positioning means such as a magnet.

A leading-edge portion (an edge portion at a rear position) of the projection 14a may be R-chamfered and shaped like a semicircle when seen in a plan view. Alternatively, the leading-edge portion of the projection 14a may be C-chamfered. Accordingly, the projection 14a may have a cross-sectional area (the area of a plane extending in the up-down direction and the left-right direction) that is orthogonal to the direction of insertion into the recess 3a (front-rear direction) and becomes smaller toward the leading-edge portion, thereby facilitating the insertion into the recess 3a.

As depicted in FIG. 2, the projection 14a is desirably provided at the center of one edge (left-right direction) of an attachment region A1 in the frame-shaped body 11 of the plate-making apparatus 10 (desirably provided on a center line C1 in the attachment region A1 that extends in the front-rear direction), the one edge being orthogonal to a direction (front-rear direction) in which the projection 14a is inserted into the recess 3a. When the recess 3a of the screen frame 1 is shifted in the left-right direction from the center in the left-right direction, the projection 14a may be shifted from the center in the left-right direction by the amount of shift of the recess 3a in the left-right direction.

The apparatus-side positioning member 14 is, as described above, attached to the attachment member 13 at the long hole 13a longer in the left-right direction than in the up-down direction, so that the position of the apparatus-side positioning member 14 can be adjusted in the left-right direction (an example of a direction orthogonal to a direction in which the projection 14a is inserted into the recess 3a).

The abutment members 15 and 16, which are located to the left of and right of the apparatus-side positioning member 14, are attached to the attachment member 13. Abutment projections 3b and 3c of the frame-side positioning member 3 abut the abutment members 15 and 16. As with the apparatus-side positioning member 14, the abutment members 15 and 16 are attached at long holes 13a in the attachment member 13 by using screws (not illustrated) so that the positions of these members can be adjusted in the left-right direction. The abutment members 15 and 16 may be omitted, and the screen frame 1 may abut an abutment part provided on the frame-shaped body 11 or the like.

The slide member 17 depicted in FIG. 1 can slide within the frame-shaped body 1 in the front-rear direction. Two pins 17a and 17b for pressing the screen frame 1 toward the abutment members 15 and 16 protrude upward on the upper surface of the slide member 17. The slide member 17 sliding frontward causes the pins 17a and 17b to press the screen frame 1, resulting in the screen frame 1 abutting the abutment members 15 and 16. The slide member 17 can be positionally fixed in the front-rear direction with the screen frame 1 abutting the abutment members 15 and 16. To cause the screen frame 1 to abut the abutment members 15 and 16, the slide member 17 which is located rearward of the screen frame 1 so as to press the screen frame 1 frontward may be omitted, and a mechanism located frontward of the screen frame 1 so as to pull the screen frame 1 frontward may be used.

As depicted in FIG. 5, the screen frame 1 includes a frame body 2 and the frame-side positioning member 3.

The frame body 2 is shaped like a rectangular frame and holds a screen (not illustrated) on, for example, the bottom surface thereof.

The frame-side positioning member 3 is shaped like a plate and located on the upper surface of a shorter edge of the frame body 2 and protrudes frontward from the periphery of the frame body 2. A recess 3a and abutment projections 3b and 3c are provided at portions of the frame-side positioning member 3 that are located frontward of the frame body 2. The recess 3a and the abutment projections 3b and 3c may be considered to be provided at an outer surface of the screen frame 1.

The projection 14a of the apparatus-side positioning member 14 is inserted into the recess 3a with the abutment projections 3b and 3c abutting the above-described abutment members 15 and 16 as a result of the above-described slide member 17 sliding frontward. Thus, shaking of the screen frame 1 in the left-right direction can be reduced. The recess 3a is desirably provided at the center of the screen frame 1 in the left-right direction. The recess 3a may be provided as an opening in the front edge of the frame-side positioning member 3 (i.e., provided on the apparatus-side-positioning-member-14 side), and the opening section may be R-chamfered. Alternatively, the opening section of the recess 3a may be C-chamfered. Accordingly, the recess 3a may have a cross-sectional area that is orthogonal to a direction (front-rear direction) in which the projection 14a is inserted and that is wider in the opening section than on the inside.

The abutment projections 3b and 3c, which are located to the left of and right of the recess 3a, protrude frontward from the front edge of the frame-side positioning member 3.

The recess 3a and the abutment projections 3b and 3c may be provided at the frame body 2, rather than at the frame-side positioning member 3 which is fixed to, but is not integral with, the frame body 2. In this case, the recess alone provided at the frame body 2 functions as the frame-side positioning part. When the apparatus-side positioning member 14 is provided with a recess, not the projection 14a as described above, the screen frame 1 may be provided with a projection to be inserted into the recess of the apparatus-side positioning member 14, instead of the recess 3a into which the projection 14a of the apparatus-side positioning member 14 is to be inserted.

For example, the frame body 2 and the frame-side positioning member 3 may be respectively provided with four attachment holes 2a and four attachment holes 3d so as to fix the frame-side positioning member 3 to the frame body 2 by using screws (not illustrated).

When the screen held by the frame body 2 of the screen frame 1 has been thermosensitively perforated by the plate-making part 12, the user slides the slide member 17 rearward and removes the screen frame 1 from the plate-making apparatus 10. Then, the user attaches the screen frame 1 to the printing apparatus 20.

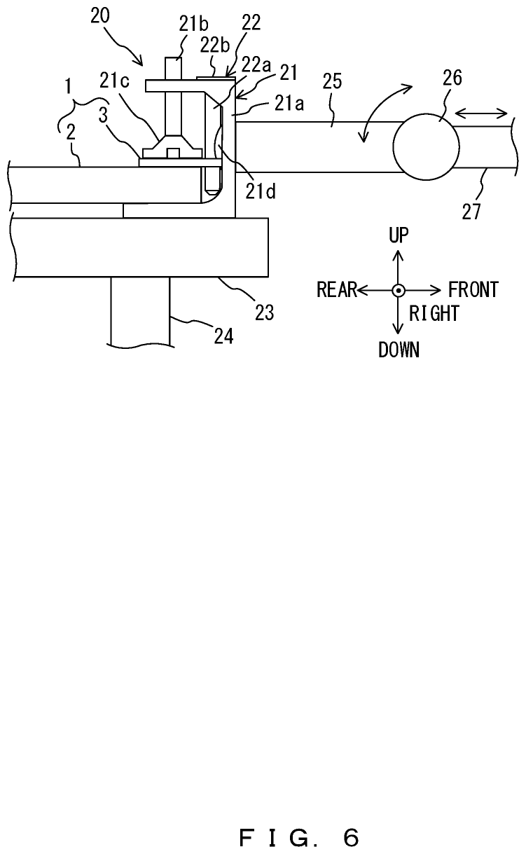

FIG. 6 is a right side view illustrating the printing apparatus 20 and the screen frame 1.

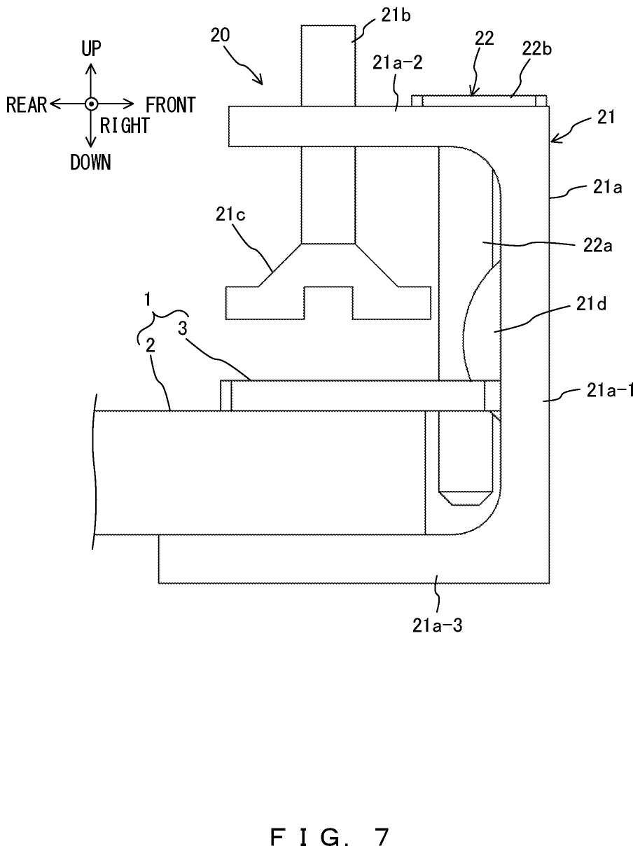

FIG. 7 is an enlarged right side view illustrating a holding part 21 and an apparatus-side positioning member 22 of the printing apparatus 20.

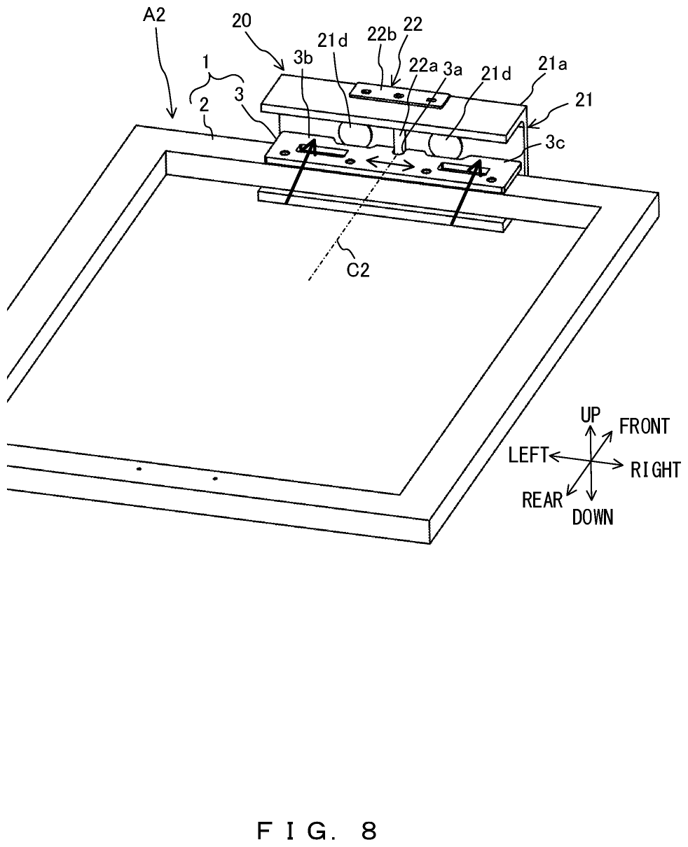

FIG. 8 is a perspective view for illustrating position adjustment of the screen frame 1 for the printing apparatus 20.

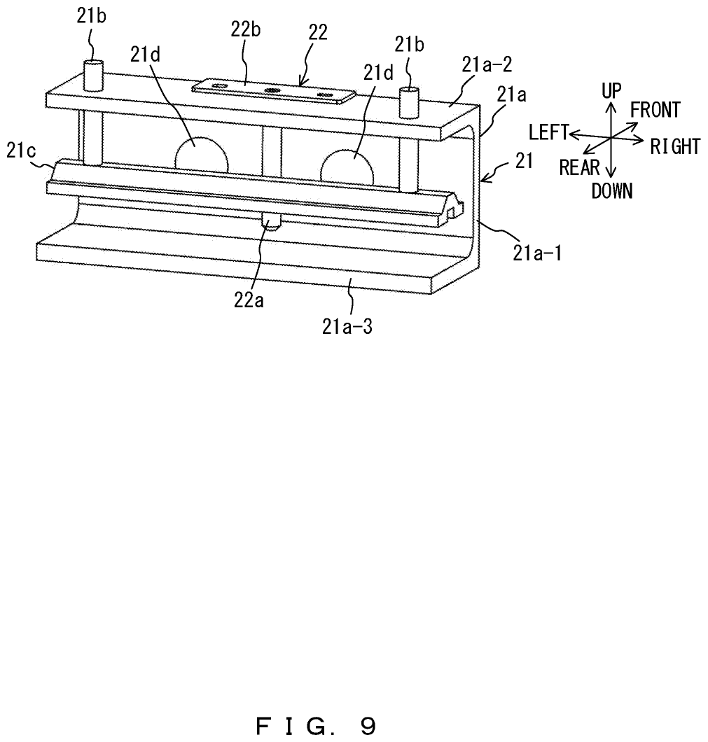

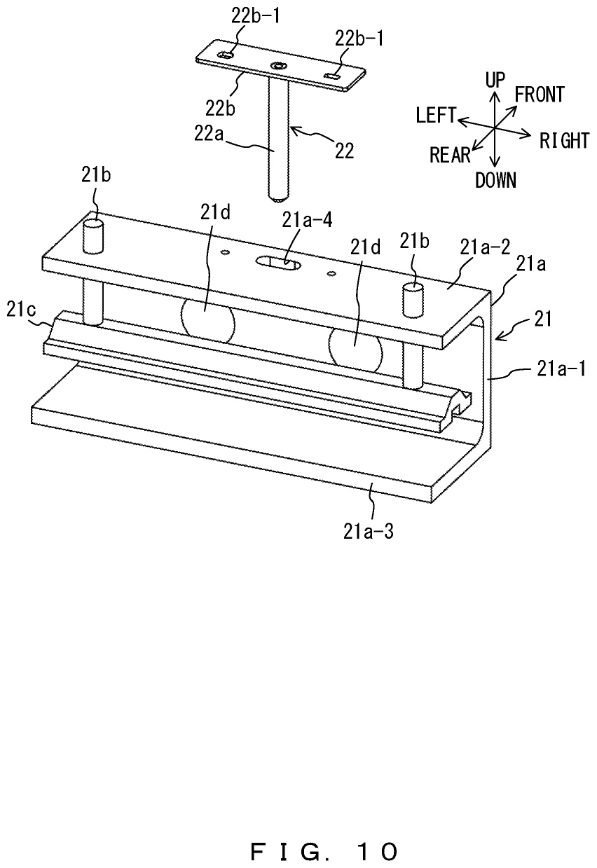

FIGS. 9 and 10 are a perspective view and an exploded perspective view illustrating the holding part 21 and the apparatus-side positioning member 22.

Note that two cap screws 21b and a pressing section 21c are not illustrated in FIG. 8.

As depicted in FIG. 6, the printing apparatus 20 includes the holding part 21, the apparatus-side positioning member 22, a mount 23, a leg part 24, a rotationally movable arm 25, a rotational-movement shaft 26, and a slide arm 27.

The holding part 21 includes a base section 21a, cap screws 21b, and a pressing section 21c and also includes, as depicted in FIG. 9, two attachment screws 21d.

The base section 21a is, for example, a laterally facing U-shaped sheet metal when seen in a right side view. The base section 21a includes an abutment vertical section 21a-1, an upper horizontal section 21a-2 extending rearward from the upper edge of the abutment vertical section 21a-1, and a lower horizontal section 21a-3 extending rearward from the lower edge of the abutment vertical section 21a-1. Abutment projections 3b and 3c of the above-described frame-side positioning member 3 abut the abutment vertical section 21a-1.

The two cap screws 21b depicted in FIG. 9 include upper portions (not illustrated) and are inserted into screw holes provided in the upper horizontal section 21a-2.

As depicted in FIGS. 6 and 7, the pressing section 21c assumes a V-shape facing downward when seen in a right side view. The pressing section 21c supports the two cap screws 21b in a rotationally movable manner and moves up or down in accordance with rotational movement of the cap screws 21b. The pressing section 21c and the lower horizontal section 21a-3 sandwich the frame-side positioning member 3 and frame body 2 of the screen frame 1. In this way, the holding part 21 holds the screen frame 1.

The two attachment screws 21d depicted in FIG. 9 fix the abutment vertical section 21a-1 of the base section 21a of the holding part 21 to the rotationally movable arm 25 illustrated in FIG. 6.

As depicted in FIGS. 9 and 10, the apparatus-side positioning member 22 includes a projection 22a and a support plate 22b. The apparatus-side positioning member 22 is an example of the apparatus-side positioning part that positions the screen frame 1.

For example, the projection 22a may be a cylindrical pin extending downward from the support plate 22b. The projection 22a is inserted into the recess 3a of the frame-side positioning member 3 of the above-described screen frame 1. The projection 22a may be integral with or separate from the support plate 22b. The projection 22a is a cylindrical pin and accordingly includes a leading-edge portion as an edge portion at a rear position that is shaped like a semicircle when seen in a plan view. Accordingly, the projection 22a may have a cross-sectional area that is orthogonal to the direction of insertion into the recess 3a (front-rear direction) and becomes smaller toward the leading-edge portion. When the frame-side positioning member 3 of the screen frame 1 is provided with a projection protruding frontward, in place of the recess 3a, the apparatus-side positioning member 22 may include, in a rear edge portion (screen-frame-1 side) thereof, a recess into which the projection is to be inserted.

As depicted in FIG. 8, the projection 22a is desirably provided at the center of one edge (left-right direction) of an attachment region A2 of the screen frame 1 that is located, for example, above the mount 23 (i.e., desirably provided on a center line C2 in the attachment region A2 that extends in the front-rear direction), the one edge being orthogonal to a direction (front-rear direction) in which the projection 22a is inserted into the recess 3a. The projection 22a is desirably provided at the center of the holding part 21 in the left-right direction. When the recess 3a of the screen frame 1 is shifted in the left-right direction from the center in the left-right direction, the projection 22a may be shifted from the center in the left-right direction by the amount of shift of the recess 3a in the left-right direction, as with the projection 14a of the apparatus-side positioning member 14. In this case, the positions (shift amounts) of the projection 14a of the apparatus-side positioning member 14 and the projection 22a of the apparatus-side positioning member 22 relative to the center in the left-right direction are equal.

The projection 22a may be provided on the holding part 21 or the like, rather than on the apparatus-side positioning member 22. In this case, the holding part 21 functions as the apparatus-side positioning part.

As depicted in FIG. 10, a long hole 21a-4 is formed through the upper horizontal section 21a-2 in the up-down direction. The long hole 21a-4 is longer in the left-right direction than in the front-rear direction. The projection 22a is inserted into the long hole 21a-4 from above. Thus, the position of the apparatus-side positioning member 22 can be adjusted in the left-right direction (an example of a direction orthogonal to a direction in which the projection 22a is inserted into the recess 3a). The support plate 22b is also provided with long holes 22b-1 that are formed through the support plate 22b in the up-down direction and longer in the left-right direction than in the front-rear direction. The apparatus-side positioning member 22 is attached to the upper horizontal section 21a-2 at the long holes 22b-1 by using screws (not illustrated).

An object for printing is placed on the mount 23 depicted in FIG. 6.

The leg part 24 supports the mount 23.

As described above, the holding part 21 is fixed to the rotationally movable arm 25 by using the two attachment screws 21d. The rotationally movable arm 25 is coupled in a rotationally movable manner via the rotational-movement shaft 26 extending in the left-right direction. Thus, the holding part 21 fixed to the rotationally movable arm 25 (and the apparatus-side positioning element 22 fixed to the holding part 21) rotationally moves with the rotational-movement shaft 26 as the center of rotational movement. Accordingly, the holding part 21 can move to a position for printing depicted in FIG. 6 at which the holding part 21 horizontally holds the screen frame 1 and to a position retracted upward from the position for printing.

The slide arm 27 is coupled to the rotational-movement shaft 26 in a rotationally nonrotatable manner and slides in the front-rear direction. Thus, the holding part 21 can rotationally move, as described above, about an axis of rotational movement extending in the left-right direction and can move in the front-rear direction together with the rotational-movement shaft 26. The position of the holding part 21 may be adjusted in the up-down direction.

When attaching the screen frame 1 to the printing apparatus 20, the user causes the abutment projections 3b and 3c of the frame-side positioning element 3 to abut the abutment vertical section 21a-1 in a manner such that as depicted in FIG. 8, the projection 22a of the apparatus-side positioning element 22 is inserted into the recess 3a of the screen frame 1, thereby reducing shaking of the screen frame 1 in the left-right direction. The user also moves down the pressing section 21c by using the cap screws 21b in a manner such that the frame-side positioning member 3 and the frame body 2 are sandwiched between the pressing section 21c and the lower horizontal section 21a-3. Then, the user performs printing on an object placed on the mount 23 by applying ink through the holes (portions for printing) in the screen by using a squeegee.

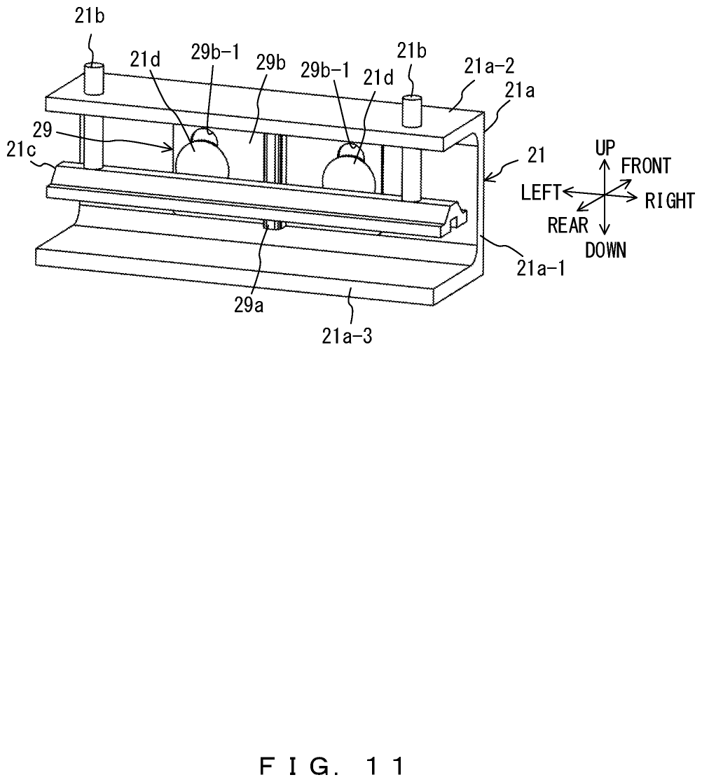

FIG. 11 is a perspective view illustrating a holding part 21 and an apparatus-side positioning member 29 in accordance with a variation.

This variation is different from the above-described examples only in that the positioning member 29 is provided in place of the apparatus-side positioning member 22. Accordingly, detailed descriptions of this variation are omitted herein.

As depicted in FIG. 11, the apparatus-side positioning member 29 includes a projection 29a and a support plate 29b. The apparatus-side positioning member 29 is an example of the apparatus-side positioning part that positions the screen frame 1.

For example, the projection 29a may protrude from the support plate 29b rearward and be shaped like a semicylinder having a central axis extending in the up-down direction. The projection 29a is inserted into the recess 3a of the frame-side positioning member 3 of the above-described screen frame 1. The projection 29a may be integral with or separate from the support plate 29b. The projection 29a is shaped like a semicylinder and accordingly includes a leading-edge portion as an edge portion at a rear position that is shaped like a semicircle when seen in a plan view. Accordingly, the projection 29a may have a cross-sectional area that is orthogonal to the direction of insertion into the recess 3a (front-rear direction) and becomes smaller toward the leading-edge portion. When the frame-side positioning member 3 of the screen frame 1 is provided with a projection protruding frontward, in place of the recess 3a, the printing apparatus 20 (e.g., holding part 21) may include a recess which is provided in a rear edge portion (screen-frame-1 side) of the apparatus-side positioning member 29 and into which the projection is to be inserted.

As with the projection 22a depicted in FIG. 8, the projection 29a is desirably provided at the center of one edge (left-right direction) of an attachment region A2 of the screen frame 1 that is located, for example, above the mount 23 (i.e., desirably provided on a center line C2 in the attachment region A2 and the apparatus-side positioning member 29 that extends in the front-rear direction), the one edge being orthogonal to a direction (front-rear direction) in which the projection 29a is inserted into the recess 3a. The projection 29a is desirably provided at the center of the holding part 21 in the left-right direction. When the recess 3a of the screen frame 1 is shifted in the left-right direction from the center in the left-right direction, the projection 29a may be shifted from the center in the left-right direction by the amount of shift of the recess 3a in the left-right direction, as with the projection 14a of the apparatus-side positioning member 14. In this case, the positions (shift amounts) of the projection 14a of the apparatus-side positioning member 14 and the projection 29a of the apparatus-side positioning member 29 relative to the center in the left-right direction are equal.

The projection 29a may be provided on the holding part 21 or the like, rather than on the apparatus-side positioning member 29. In this case, the projection alone or the holding part 21 functions as the apparatus-side positioning part.

The support plate 29b is fixed to the abutment vertical section 21a-1 of the base section 21a by the two cap screws 21b for fixing, as described above, the holding part 21 to the rotationally movable arm 25.

The support plate 29b has two long holes 29b-1 formed therethrough in the front-rear direction. The long holes 29a-1 are longer in the up-down direction than in the left-right direction. Thus, the position of the apparatus-side positioning member 29 can be adjusted in the up-down direction (an example of a direction orthogonal to a direction in which the projection 29a is inserted into the recess 3a). The apparatus-side positioning member 29 may be disposed in a manner such that the position of thereof can be adjusted in the left-right direction (another example of a direction orthogonal to a direction in which the projection 29a is inserted into the recess 3a).

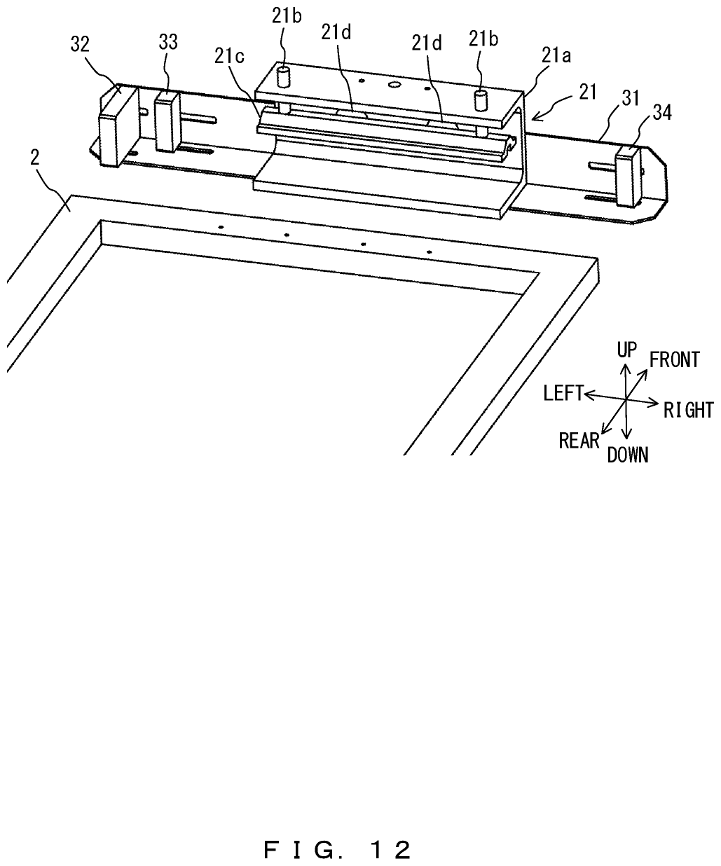

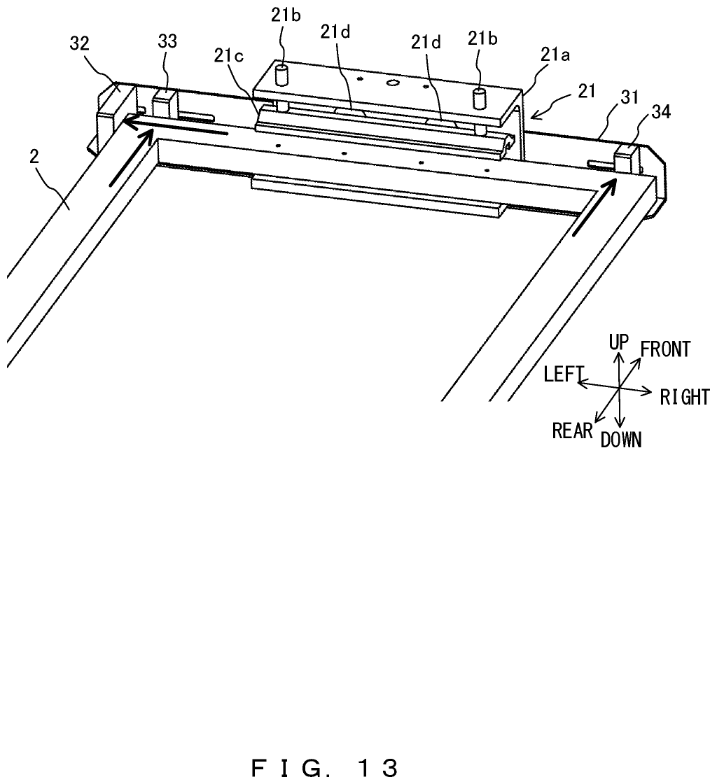

FIGS. 12 and 13 are perspective views for illustrating position adjustment of a screen frame (frame body 2) in accordance with a comparative example.

In this comparative example, the above-described frame-side positioning member 3 is not fixed to the frame body 2. Accordingly, the frame body 2 alone serves as a screen frame. The apparatus-side positioning member 22 is not fixed to the holding part 21, and the frame body 2 does not abut the base section 21a. The apparatus-side positioning member 22 may be fixed to the holding part 21, and the position of the screen frame 1 may be adjusted using the apparatus-side positioning member 22 together with a corner abutment member 32 and abutment members 33 and 34 described hereinafter.

An attachment member 31 is, for example, an L-shaped sheet metal fixed to the holding part 21. The attachment member 31 has attached thereto the corner abutment member 32, which is to be abutted in the leftward direction by a corner of the frame body 2 that is formed between the left and front edges of the frame body 2.

The attachment member 31 has also attached thereto the two abutment members 33 and 34, which are to be abutted by the frame body 2 in the frontward direction.

When adjusting the position of the frame body 2 by using the corner abutment member 32 and the abutment members 33 and 34, the user causes the frame body 2 to abut the abutment members 33 and 34 in the frontward direction and causes the frame body 2 to abut the corner abutment member 32 in the leftward direction. Then, the user fixes the frame body 2 in a sandwiching manner by means of the holding part 21. In a case where a single holding part 21 alone is disposed, when the positions of a plurality of types of frame bodies 2 that are different in size in the left-right direction need to be adjusted, the screen frame 1 cannot be held at the center of the screen frame 1 in the left-right direction, and hence the position of the corner abutment member 32 needs to be moved in the left-right direction.

In the embodiments described so far, the plate-making apparatus 10 and printing apparatus 20 (examples of the screen-frame attachment apparatus) to which the screen frame 1 for holding a screen is attached respectively include the apparatus-side positioning members (examples of apparatus-side positioning part) 14 and 22 for positioning the screen frame 1, in association with the recess 3a in the frame-side positioning member (an example of the screen-frame attachment part) 3 provided on the periphery of the screen frame 1. The apparatus-side positioning members 14 and 22 position the screen frame 1 respectively in accordance with the projections 14a and 22a being inserted into the recess 3a provided in the frame-side positioning member 3.

Accordingly, the user can position the screen frame 1 in the left-right direction for the plate-making apparatus 10 or the printing apparatus 20 through the simple operation of inserting the projection 14a or 22a of the apparatus-side positioning member 14 or 22 into the recess 3a provided at the periphery of the screen frame 1. Hence, the plate-making apparatus 10 and the printing apparatus 20 do not need to be increased in size in comparison with an aspect in which the position of the screen frame 1 is adjusted using both a position adjustment mechanism for the left-right direction and that for the front-rear direction. In the case of a configuration in which, as in the comparative example depicted in FIGS. 12 and 13, the user adjusts the position of the screen frame 1 (frame body 2) by causing the screen frame to abut the abutment members 33 and 34 in the front-rear direction and causing the screen frame to abut the corner abutment member 32 in the left-right direction, the corner abutment member 32 is disposed for positioning in the left-right direction, thereby complicating the structure, and moving the corner abutment member 32 in the left-right direction so as to adapt to the sizes of a plurality of types of frame bodies 2 will involve troubles or require efforts. Accordingly, the embodiments allow the position of the screen frame 1 to be easily adjusted with a simple configuration.

In the embodiments, the apparatus-side positioning members 14 and 22 respectively include projections 14a and 22a having cross-sectional areas that are orthogonal to the directions of insertion of the projections 14a and 22a into the recess 3a (front-rear direction) and become smaller toward the leading-edge portions. The recess 3a of the frame-side positioning member 3 has a cross-sectional area that is wider in the opening section than on the inside. Similarly, when the apparatus-side positioning members 14 and 22 are provided with recesses and the frame-side positioning member 3 is provided with a projection, the apparatus-side positioning members 14 and 22 are each provided with a recess having a cross-sectional area that is wider in the opening section than on the inside, and the frame-side positioning member 3 is provided with a projection having a cross-sectional area that becomes smaller toward the leading-edge section. Hence, the insertion of the projection 14a or 22a into the recess 3a is facilitated so that the position of the screen frame 1 can be adjusted more easily.

In the embodiments, the apparatus-side positioning members 14 and 22 are each provided at the center of one edge of the attachment region A1 or A2 of the screen frame 1 (i.e., provided on the center line C1 or C2 in the attachment region A1 or A2), the one edge being orthogonal to a direction in which the projection 14a or 22a is inserted into the recess 3a. Accordingly, the apparatus-side positioning members 14 and 22 can position the screen frame 1 at the center in the left-right direction of the screen frame 1 irrespective of the size of the screen frame 1, so that the screen frame 1 can be stably attached.

In the embodiments, the position of the apparatus-side positioning member 14 or 22 can be adjusted in a direction (e.g., left-right direction or up-down direction) orthogonal to a direction in which the projection 14a or 22a is inserted into the recess 3a. Accordingly, the positions of the apparatus-side positioning members 14 and 22 can be easily adjusted in conformity with, for example, the position of the recess 3a of the screen frame 1.

In the embodiments, the plate-making printing system includes the plate-making apparatus 10 to which a screen frame 1 is to be attached and the printing apparatus 20 to which a screen frame 1 is to be attached. The plate-making apparatus 10 and the printing apparatus 20 each include the apparatus-side positioning part (e.g., apparatus-side positioning member 14, 22) for positioning the screen frame 1, the apparatus-side positioning part being associated with the frame-side positioning part (e.g., screen-frame positioning member 3) provided on the periphery of the screen frame 1. The apparatus-side positioning member 14 of the plate-making apparatus 10 and the apparatus-side positioning member 22 of the printing apparatus 20 are each provided at the center of one edge of the attachment region A1 or A2 of the screen frame 1 in the left-right direction of the screen frame 1 (i.e., provided on the center line C1 or C2 in the attachment region A1 or A2), or the positions (shift amount) of these members relative to the center are equal. Hence, the position of the screen frame 1 can be adjusted through simple operations with reference to a predetermined position (e.g., center) on the attachment region A1 or A2 for the plate-making apparatus 10 or the printing apparatus 20. The plate-making apparatus 10 and the printing apparatus 20 position the screen frame 1 by means of the same frame-side positioning member 3, so that the position for plate making or the position for printing can be made less likely to be offset with a simple configuration, thereby enhancing the accuracy in plate making or printing.

In the embodiments, one of the apparatus-side positioning part (apparatus-side positioning members 14 and 22) or the frame-side positioning part (frame-side positioning member 3) is the projection 14a or 22a, and the other is the recess 3a. Accordingly, the user can position the screen frame 1 in the left-right direction for the plate-making apparatus 10 or the printing apparatus 20 through the simple operation of inserting the projection 14a or 22a (or recess) of the apparatus-side positioning member 14 or 22 into the recess 3a provided at (or a projection provided on) the periphery of the screen frame 1.

In the embodiments, the recess 3a (or projection) of the screen frame 1 is provided at the frame-side positioning member 3 separate from the frame body 2. Thus, the screen frame 1 can be easily provided with the recess 3a (or projection) by attaching the frame-side positioning member 3 to an existing frame body 2. The recess 3a (or projection) can be provided at the screen frame 1 when it is difficult to provide the recess 3a (or projection) directly at the frame body 2 for some reason related to processing.

The present invention is not simply limited to the embodiments described herein. Components of the embodiments may be embodied in a varied manner in an implementation phase without departing from the gist of the invention. A plurality of components disclosed with reference to the described embodiments may be combined, as appropriate, to achieve various inventions. For example, all of the components indicated with reference to embodiments may be combined as appropriate. Accordingly, various variations and applications can be provided, as a matter of course, without departing from the gist of the invention. The following indicates, as appendixes, the inventions recited in the claims of the Japanese application as originally filed.

Appendix 1. A screen-frame attachment apparatus to which a screen frame for holding a screen is to be attached, the screen-frame attachment apparatus comprising:

an apparatus-side positioning part that positions the screen frame, the apparatus-side positioning part being associated with a frame-side positioning part provided on a periphery of the screen frame, wherein

the apparatus-side positioning part positions the screen frame in accordance with a projection provided on one of the apparatus-side positioning part or the frame-side positioning part being inserted into a recess provided in another of the two parts.

Appendix 2. The screen-frame attachment apparatus of appendix 1, wherein

the apparatus-side positioning part includes the projection, which has a cross-sectional area that is orthogonal to a direction in which the projection is inserted into the recess and becomes smaller toward a leading-edge portion, or the recess, which has a cross-sectional area that is wider in an opening section than on an inside.

Appendix 3. The screen-frame attachment apparatus of appendix 1 or 2, wherein

the apparatus-side positioning part is provided at a center of one edge of an attachment region of the screen frame, the one edge being orthogonal to a direction in which the projection is inserted into the recess.

Appendix 4. The screen-frame attachment apparatus of any of appendixes 1-3, wherein

a position of the apparatus-side positioning part is capable of being adjusted in a direction orthogonal to a direction in which the projection is inserted into the recess.

Appendix 5. A plate-making printing system comprising:

a plate-making apparatus to which a screen frame is to be attached; and

a printing apparatus to which the screen frame is to be attached, wherein

the plate-making apparatus and the printing apparatus each include an apparatus-side positioning part that positions the screen frame, the apparatus-side positioning parts being associated with a frame-side positioning part provided on a periphery of the screen frame, and

the apparatus-side positioning part of the plate-making apparatus and the apparatus-side positioning part of the printing apparatus are each provided at a center of one edge of an attachment region of the screen frame in a left-right direction of the screen frame, or positions of the two parts relative to the center are equal.

Appendix 6. The plate-making printing system of appendix 5, wherein

one of the apparatus-side positioning part or the frame-side positioning part is a projection, and another of the two parts is a recess.

What is claimed is:

1. A screen-frame attachment apparatus to which a screen frame for holding a screen is to be attached, the screen-frame attachment apparatus comprising:
an apparatus-side positioning part that positions the screen frame, the apparatus-side positioning part being associated with a frame-side positioning part provided on a periphery of the screen frame, wherein
the apparatus-side positioning part positions the screen frame in accordance with a projection provided on one of the apparatus-side positioning part or the frame-side positioning part being inserted into a recess provided in another of the two parts.

2. The screen-frame attachment apparatus of claim 1, wherein
the apparatus-side positioning part includes the projection, which has a cross-sectional area that is orthogonal to a direction in which the projection is inserted into the recess and becomes smaller toward a leading-edge portion, or the recess, which has a cross-sectional area that is wider in an opening section than on an inside.

3. The screen-frame attachment apparatus of claim 1, wherein
the apparatus-side positioning part is provided at a center of one edge of an attachment region of the screen frame, the one edge being orthogonal to a direction in which the projection is inserted into the recess.

4. The screen-frame attachment apparatus of claim 2, wherein
the apparatus-side positioning part is provided at a center of one edge of an attachment region of the screen frame, the one edge being orthogonal to a direction in which the projection is inserted into the recess.

5. The screen-frame attachment apparatus of claim 1, wherein
a position of the apparatus-side positioning part is capable of being adjusted in a direction orthogonal to a direction in which the projection is inserted into the recess.

6. The screen-frame attachment apparatus of claim 2, wherein
a position of the apparatus-side positioning part is capable of being adjusted in a direction orthogonal to a direction in which the projection is inserted into the recess.

7. The screen-frame attachment apparatus of claim 3, wherein
a position of the apparatus-side positioning part is capable of being adjusted in a direction orthogonal to a direction in which the projection is inserted into the recess.

8. The screen-frame attachment apparatus of claim 4, wherein
a position of the apparatus-side positioning part is capable of being adjusted in a direction orthogonal to a direction in which the projection is inserted into the recess.

9. A plate-making printing system comprising:
a plate-making apparatus to which a screen frame is to be attached; and
a printing apparatus to which the screen frame is to be attached, wherein
the plate-making apparatus and the printing apparatus each include an apparatus-side positioning part that positions the screen frame, the apparatus-side positioning parts being associated with a frame-side positioning part provided on a periphery of the screen frame, and
the apparatus-side positioning part of the plate-making apparatus and the apparatus-side positioning part of the printing apparatus are each provided at a center of one edge of an attachment region of the screen frame in a left-right direction of the screen frame, or positions of the two parts relative to the center are equal.

10. The plate-making printing system of claim 9, wherein
one of the apparatus-side positioning part or the frame-side positioning part is a projection, and another of the two parts is a recess.
